(19) United States
(12) Patent Application Publication
(10) Pub. No.: US 2015/0125601 A1
(43) Pub. Date: May 7, 2015

(54) METHOD AND APPARATUS FOR PRODUCING NANOSILICON PARTICLES

(71) Applicant: Systems and Materials Research Corporation, Austin, TX (US)

(72) Inventor: David J. IRVIN, Austin, TX (US)

(21) Appl. No.: 14/532,821

(22) Filed: Nov. 4, 2014

Related U.S. Application Data
(60) Provisional application No. 61/899,761, filed on Nov. 4, 2013.

(51) Int. Cl. C01B 33/021; C06B 27/00

(52) U.S. Cl. CPC C01B 33/021; C06B 27/00
USPC 427/220; 423/350

(57) ABSTRACT

A method and apparatus for the production of nano-sized silicon particles via a low-temperature chemical solid-liquid reaction between a silicon-containing compound and a reducing agent. Embodiments of the present invention provide a production method that is cost-effective, while producing elemental silicon having purity, particle sizes, and stability suitable for energetics applications including solid propulsion additives, igniters, flares, decoys, and liquid fuel catalysts.

### CROSS-REFERENCE TO RELATED APPLICATION

This application claims priority under 35 U.S.C. §119(e) to U.S. Provisional App. No. 61/899,761, entitled “Method and Apparatus for Producing Nanosilicon Particles”, by David J. Irvin, filed Nov. 4, 2013, which is assigned to the current assignee hereof and incorporated herein by reference in its entirety.

### FIELD OF THE DISCLOSURE

The present invention relates in general to the production of high purity silicon nanoparticles, and more particularly to the cost-effective production of nanosilicon suitable for use in propellants, explosives, or thermites.

### BACKGROUND

Metallic nanoparticles show great potential for use in a variety of energetic applications including combustion (for example, in propellants, explosives, or thermites), electrolysis, and catalysis. During combustion processes, the high surface area of metallic nanoparticle fuels allows for complete and consistent conversion of the solid material into usable energy. Although the energy density of metallic nanoparticles is below that of hydrocarbons, the ability to store metal fuels for extended periods of time with no degradation and without monitoring makes these materials highly desirable.

Beryllium and boron have the highest heats of combustion (H_{c}) of the metals/metalloids. Unfortunately, the high cost of these materials far exceeds any potential advantage in energy storage. Nanoaluminum (nAl) represents the most commercially viable material for combustion applications and has been successfully used in a variety of propellants, explosives, or thermites (including nanothermites). Unfortunately, nAl does not have a long shelf life. Unless stored under inert conditions, the material readily develops a 4-6 nm oxide layer, which can significantly diminish its energetic performance.

As compared to nAl, silicon nano-powder (nSi) has a comparable H_{c} and forms a much thinner (1-2 nm) oxide layer, resulting in superior aging characteristics and a longer shelf life. Unfortunately, known production methods for nSi are not cost effective and generally do not result in nSi having a high purity.

What is needed therefore is an improved method and apparatus for production of nanosilicon (nSi) that is cost effective and that produces nSi with purity and particle size characteristics optimal for use in propellants and explosives.

### BRIEF DESCRIPTION OF THE DRAWINGS

The present disclosure may be better understood, and its numerous features and advantages made apparent to those skilled in the art by referencing the accompanying drawings.

FIG. 1 shows a flowchart illustrating a process for producing high purity elemental silicon in accordance with a particular embodiment of the invention described herein.

FIGS. 2A-2C shows Brownian Motion Microscope data for three solvent-based reactions according to embodiments of the present invention.

The accompanying drawings are not intended to be drawn to scale. In the drawings, each identical or nearly identical component that is illustrated in various figures is represented by a like numeral. For purposes of clarity, not every component may be labeled in every drawing.

### DETAILED DESCRIPTION OF PREFERRED EMBODIMENTS

This disclosure, in general, relates to a method and apparatus for the production of nano-sized silicon particles (nanosilicon or nSi) via a low-temperature mechano-chemical solid-liquid reaction between a silicon-containing compound and a reducing agent. Embodiments of the present invention provide a production method that is cost-effective, while producing elemental silicon having purity, particle sizes, and stability suitable for energetics applications including solid propulsion additives, igniters, flares, decoys, and liquid fuel catalysts.

In one embodiment, nSi can be produced by reacting silicon tetrachloride (SiCl4) with magnesium (Mg) powder using ball milling to produce sufficient mechanical energy to promote the reaction and to prevent to buildup of the magnesium chloride (MgCl2) byproduct on the magnesium surfaces, which would inhibit further reaction. In other particular embodiments, one or more solvents are added to the SiCl4 and Mg to dissolve the MgCl2 and activate the reaction, with or without the ball milling or other agitation. Surprisingly, Applicants have discovered that a combination of tetrahydrofuran (THF) and toluene with the SiCl4 and Mg starting materials at room temperature and in the absence of agitation unexpectedly resulted in a spontaneous, rapid, exothermic reduction of the SiCl4, thus producing high-purity nSi particles in a fraction of the time required for the embodiments utilizing high speed ball milling without THF.

A method or apparatus according to embodiments of the present invention has many novel aspects. Because the invention can be embodied in different methods or apparatuses for different purposes, not every aspect need be present in every embodiment. Moreover, many of the aspects of the described embodiments may be separately patentable. Embodiments of the present invention can include production methods, production apparatuses, and/or products made using such methods or apparatuses. The figures described herein are generally schematic and do not necessarily portray the embodiments of the invention in proper proportion or scale unless otherwise stated. Further, although much of the description herein is directed at nSi for applications such as propellants, explosives, or thermites, it should be recognized that embodiments of the invention could be applicable to any application where elemental silicon can be employed, including without limitation photovoltaic devices, printed circuit devices, quantum dots, medical diagnostics, fuel, fuel additives, and/or catalysts.

As used herein, “low temperatures” will be used to mean temperatures below the melting point of either the silicon-containing compound or the reducing agent. The phrase “room temperature” will be used to refer to a reaction condition where no heat is added to the reactants or the container in which the reaction takes place; in other words, where the reaction takes place at ambient temperature. As used herein, the temperatures encompassed by the term “room temperature” will be somewhat broader, usually from about 60° F. to about 100° F.

On an industrial scale, elemental silicon can be produced by reacting a silicon source with a reducing agent to produce silicon and a salt by-product. For example, reducing silicon tetrachloride (a silicon source) with magnesium (a reducing agent) in high-temperature furnaces typically produces pure silicon and magnesium chloride (a salt) according to:

SiCl₄+2Mg [symbol] 2MgCl₂+Si

However, this type of conventional method of producing elemental silicon typically requires the reaction to take place in the molten phase. Thus, in this particular example, the silicon tetrachloride and magnesium must be heated to a temperature of at least 650° C. (the melting point of magnesium) before reacting, which requires a great deal of energy and expense. The process is also relatively long, requiring several days to complete the reaction. Furthermore, the silicon final product is typically not of sufficient quality to use in many energetics applications without additional purification steps.

In contrast, according to embodiments of the present invention, elemental silicon can be produced by reacting a silicon source with a reducing agent via a low-temperature, or even room temperature, mechano-chemical solid-liquid reaction. The elemental silicon produced is in the form of highly pure silicon nanoparticles. Particular embodiments also allow for continuous production, rather than batch production, which contributes to higher production with lower operating costs than known Si production methods.

In general, a suitable silicon source for a reducing reaction according to embodiments of the invention can comprise a silicon-containing compound in which silicon is present in a plus 4 oxidation state, such as a silicon halide including silicon tetrafluoride (SiF4), silicon tetrachloride (SiCl4), silicon tetrabromide (SiBr4), silicon tetraiodide (SiI4), or any combination thereof. A suitable silicon source could also comprise a silicon hydrocarbon halide, such as Si(Cl)₃,R (where R is any aliphatic or aromatic hydrocarbon, aliphatic or aromatic ether or a halogenated aliphatic or aromatic hydrocarbon, or halogenated aliphatic or aromatic ether), or a mixed hydrocarbon halide such as (Si(Cl)₂(R)₂), (Si(R)₃(Cl)), or any combination thereof. A suitable silicon source could also comprise a silicon ester, such as Si(OAc)₄, (where OAc is —O—CO—CH₃), Si(OPr)₄, (where OPr is —O—CO—CH₂—CH₃), or a mixed ester such as (Si(OAc)₂(OPr)₂), (Si(OAc)₃(OPr)), or any combination thereof; a silane, such as SiH₄, or SiH₂(CH₃)₂, or a mixed silane such as SiH₂Cl₂, SiH₂(OCH₃)₂, SiH₂(OAc)₂, or any combination thereof; a mixed halide such as SiF₂Cl₂, SiFCl₃, SiBr₂Cl₂, or any combination thereof; a silicon alkoxide such as Si(OMe)₄, Si(OEt)₄, Si(OPr)₄, (Si(OCH₃)₄), (Si(OC₂H₅)₄), (Si(OC₃H₇)₄), or any combination thereof; or a mixed alkoxide such as (Si(OC₂H₅)₂(OCH₃)₂), (Si(OC₂H₅)₃(OCH₃)), or any combination thereof.

A suitable reducing agent can comprise Mg, Al, Li, Na, K, Ca, Cu, Cs, Sr, Be, Zn, Zr, Ba, Mn, Cr, P, B, NH₃, NaBH₄, LiAlH₄, or any combination thereof. Typically the reducing agent, such as Mg, will be in the form of a powder.

In some embodiments, nSi can be produced by reacting a reducing agent, such as magnesium (Mg) powder, with a silicon source, such as silicon tetrachloride (SiCl₄), at low temperatures or room temperatures in the presence of a mechanical activator. In a particular embodiment, the starting materials (liquid SiCl₄ and powdered Mg) are combined and subjected to High Speed Ball Milling (HSBM), which imparts sufficient mechanical energy to the starting materials through collisions with the milling media and the reaction vessel walls to promote the reduction of SiCl₄ by the magnesium and produce elemental Si. In some embodiments, other types of mechanical activators could be used, including jet grinding, sonication, high shear mixing, high or low pressure homogenization, or wet grinding.

As the reaction progresses, the reaction's non-silicon containing byproduct, such as magnesium chloride (MgCl₂), tends to build up on the surface of the metal particles as the reaction progresses. Such buildup is undesirable because the surface of the Mg particles must remain exposed to ensure completeness of reaction. The agitation caused by the high speed ball milling is sufficient to break apart the MgCl₂ and metal particles to prevent such a buildup from occurring.

Unfortunately, reactions using HSBM are quite slow. In numerous experiments, Applicants confirmed that the ball milling process must continue for as long as three days before the reaction will be complete. Further, even after three days the purity of the silicon can be undesirably low due to the presence of unreacted Mg, which has been blocked from reacting by the presence of the MgCl₂ by-product despite the HSBM. The yield of nSi is also undesirably low because the volumes of starting materials are constrained by the volume of the ball milling container. The ball milling process is also a batch process that cannot be easily scaled into a continuous process.

Given that the buildup of MgCl₂ can stop the Si production methods described above from progressing to completion, Applicants theorized that a solvent could be used to dissolve MgCl₂ as it is formed. The use of any sort of volatile solvent would be impractical for the high-temperature Si production methods of the prior art, but at temperatures closer to room temperature there are a number of solvents that could be potentially used to dissolve the MgCl₂. Thus, in some particular embodiments, a solvent that dissolves MgCl₂ can be added to the silicon source (such as SiCl₄) and the reducing agent (such as Mg) before or during subjecting the mixture to HSBM. The use of such a MgCl₂ solvent can reduce the time it takes the reaction to proceed to completion and can also result in higher purity nSi by reducing or eliminating the presence of unreacted Mg particles.

In other particular embodiments, the reaction can proceed as a purely solvent-based reaction by reducing the silicon containing compound in the presence of a solvent/activator such as tetrahydrofuran at low temperatures and without mechanical agitation.

In evaluating the efficacy of using such a solvent in conjunction with agitation of the reactive starting materials as described above, Applicants unexpectedly discovered that the addition of a quantity of tetrahydrofuran (THF) to the starting materials resulted in a spontaneous, rapid, exothermic reduction of the SiCl₄ to elemental Si. In a particular example, about 18.75 ml of tetrahydrofuran (THF) was added to about 0.3 grams of magnesium in an inert atmosphere. About 6.25 ml of silicon tetrachloride (a stoichiometric excess) was added in one addition. Within 5 minutes the mixture had changed color and a red/brown solid was observed without any visible magnesium metal. There was no change in the appearance of the reaction after five minutes. Analysis of the solid Si produced showed that the yield was near the theoretical yield. Significantly, this reaction progressed to completion at room temperature without any HSBM or other mechanical agitation and in a fraction of the time required for the HSBM processes described above.

At this time, the exact nature of the activation of the SiCl4 reduction caused by THF is still unknown, but the embodiments described herein have been shown to work, regardless of the underlying mechanism. Accordingly, Applicants' claims to their invention are not bound by any particular theory of operation. Applicants believe, however, that the THF is functioning as a chemical “activator,” a term used herein to mean a compound which causes an increased propensity for a chemical reaction to occur. It may be that in addition to dissolving the salt byproduct as it forms, the THF is serving to enhance the rate of reaction of the silicon source and the reducing agent and/or serving to decrease the initiation energy (whether from temperature, mechanical energy, etc.) of the reaction. One possible activation mechanism might be that the activator acts as a Lewis base. The silicon halides act as a Lewis acid and thus the activator forms a Lewis acid: Lewis base complex. In particular embodiments any Lewis acid could be used as an activator. This includes but is not limited to ketones, ethers, esters, amides, nitriles, nitro compounds, aromatic bases and amines. Examples of these include but are not limited to THF, diethyl ether, acetone, acetonitrile, benzene, benzonitrile, N,N-dimethylacetimide (DMAC), N,N-dimethylformamide (DMF), dimethylsulfoxide, ethylacetate, formamide, hexamethylphosphoramide, 1-methyl-2-pyrrolidone (NMP), nitrobenzene, nitromethane, propylene carbonate, and pyridine. The activator may or may not be used as the solvent.

Thus, a process for producing high purity elemental silicon comprises the steps of combining a silicon source, such as silicon tetrachloride (SiCl₄), with a reducing agent, such as magnesium (Mg) powder, in the presence of a chemical activator such as THF. The reaction producing the elemental silicon nanoparticles is spontaneous once the silicon source, reducing agent, and chemical activator are combined. Preferably the reduction of the silicon source takes place at a temperature that is lower than the highest melting point of any of the solid reactants or starting materials, such as at a temperature of less than about 500° C., less than about 300° C., or less than about 200° C. In some embodiments the reduction of the silicon source can take place at room temperature, with no heat added to the reaction, such as less than about 100° C., less than about 75° C., less than about 70° C., or from about 60° C. to 100° C.

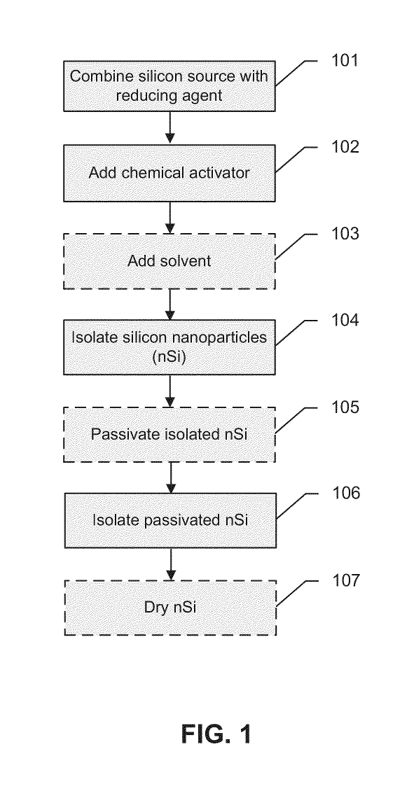

FIG. 1 shows a flowchart 100 illustrating a process for producing high purity elemental silicon in accordance with a particular embodiment of the invention described herein. As discussed below, the order and rate of addition of the silicon source, reducing agent, and chemical activator has a great effect upon nSi particle size and agglomerate behavior and can be varied as desired in particular embodiments. In the embodiment of FIG. 1, a silicon source, such as silicon tetrachloride (SiCl₄), is first combined with a reducing agent, such as magnesium (Mg) powder in step 101. In step 102, a chemical activator such as THF is then added to the mixture, which is kept at room temperature, with no heat added to the reaction.

The THF-activated reaction progresses to completion without any HSBM or other mechanical agitation and in a fraction of the time required for the HSBM processes described above. In particular embodiments, the reaction producing the elemental silicon nanoparticles is substantially completed within about 24 hours, within about 12 hours, within about 6 hours, within about 4 hours, within about 2 hours, or within about 1 hour from the time the silicon source, reducing agent, and chemical activator are combined. In particular embodiments, the chemical activator is a solvent capable of dissolving a non-silicon containing salt or byproduct of the reaction. The chemical activator can comprise THF, propylene carbonate (PC), linear, cyclic, and/or polymeric esters, dry alcohols, diether ether (ether), linear, cyclic, and/or polymeric ethers, or any combination thereof.

In some embodiments, a solvent other than the chemical activator can also be added to the reaction mixture in step 103. For example, toluene can be used as a solvent and mixed with the silicon source, reducing agent, and chemical activator. Applicants have discovered that, although MgCl₂ is soluble in toluene, toluene alone does not activate the spontaneous reaction between silicon source and reducing agent like THF. In one particular example, about 20 ml of toluene was added to about 0.3 grams of magnesium in an inert atmosphere. About 6.25 ml of silicon tetrachloride (a stoichiometric excess) was added in one addition. After 5 min, no visible reaction was observed. About 5 ml of THF was added in one addition. The solution began to change color almost immediately. After 45 minutes, the lack of observable magnesium metal indicated that the reaction was complete. Analysis of the solid Si produced again showed that the yield was near the theoretical yield.

Applicants have determined that if as little as 10 vol % of THF is added to the toluene, the reaction will go to completion. The addition of another solvent like toluene serves to mitigate the exothermic nature of the reaction. Applicants have observed that using toluene as a solvent and adding THF as an activator results in a much lower reaction exotherm, while still causing the reaction to run to completion in less than four hours. This behavior is especially significant for the production of nSi in commercial quantities using this type of solvent-based reaction.

Additionally, as discussed in greater detail below, the order and rate of addition of the silicon source, reducing agent, and chemical activator has a great effect upon nSi particle size and agglomerate behavior. Using toluene as a solvent allows the rate of addition of the THF to be controlled, which can be used to produce nSi particles of a desired size.

As also discussed below, once the nSi has been produced using embodiments of the invention as described above, in step 104 the silicon nanoparticles can be isolated from the reaction mixture using filtration, dialysis, evaporation, pervaporation, diafitration, cross flow filtration, nanofiltration, centrifugal separation, and/or sedimentation.

In optional step 105, the isolated nSi can then be passivated to reduce the reactivity of the nSi and improve shelf-life. Passivation can be accomplished by forming an organic passivation layer on the surfaces of the silicon nanoparticles using an alkene or alkyne such as phenyl acetylene and/or hexyne, a carboxylic acid such as acetic acid or palmitic acid, or a mono-, di-, or trifunctional silane such as trimethoxyoctyl silane or using various organometallic reagents such as alkyl Grignard reagents (organo-magnesium), organo-tin, organo-zinc, organo-copper, organo-lithium, and/or organo-nickel compounds. In other embodiments, passivation can be accomplished by forming an organic passivation layer on the surfaces of the silicon nanoparticles using an alcohol to from a Si—O—R bond using any single or mixture of alcohols. These alcohols can be primary, secondary, or tertiary in nature and can be but are not limited to aliphatic, aromatic, linear, branched, cyclic, aliphatic ether, and/or halogenated. Passivation can also be accomplished by forming an non-organic passivation layer on the surfaces of the silicon nanoparticles using a hydride forming a Si—H bond on the surface of the particle. This can performed using any of a number of hydride containing agents including but not limited to LiAlH₄, NaBH₄, NaBH₃CNBH₃, AlH₃, B₂H₆, and LiAlH₂ (OCH₂CH₂OCH₃)₂. In some embodiments a mixture of silicon nanoparticles and a passivating agent is sonicated for a period of time, for example for about 20 minutes, in order to fully coat the surfaces of the nSi particles and prevent oxidation.

After passivation, in step 106, the nSi particles can again be isolated using any of the methods described previously. For production on a commercial scale, in optional step 107, the nSi particle in the mixture could be quickly turned into a solid dry powder using a spray-drying system.

The elemental silicon produced according to the embodiments described above will typically be in the form of amorphous nSi powder. For example, ball milled samples produced silicon particles of ˜20-25 nm in diameter with 100-150 nm agglomerates while mechanically stirred samples produced ˜10 nm particles and 100 nm agglomerates.

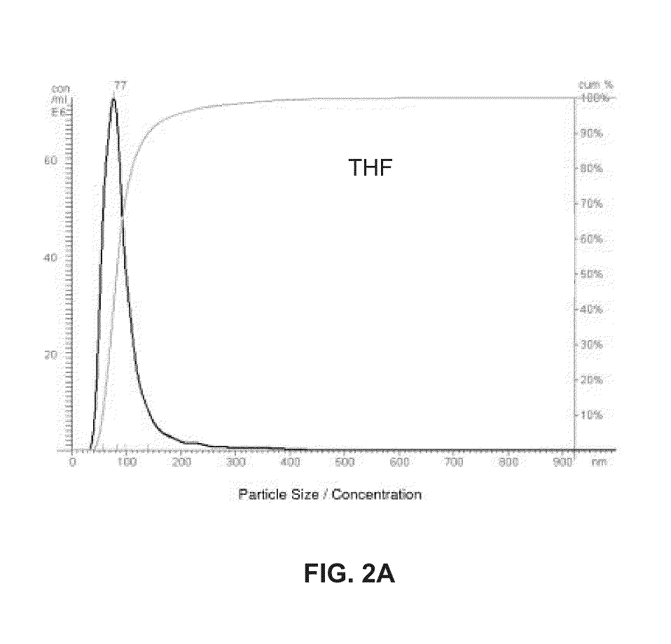

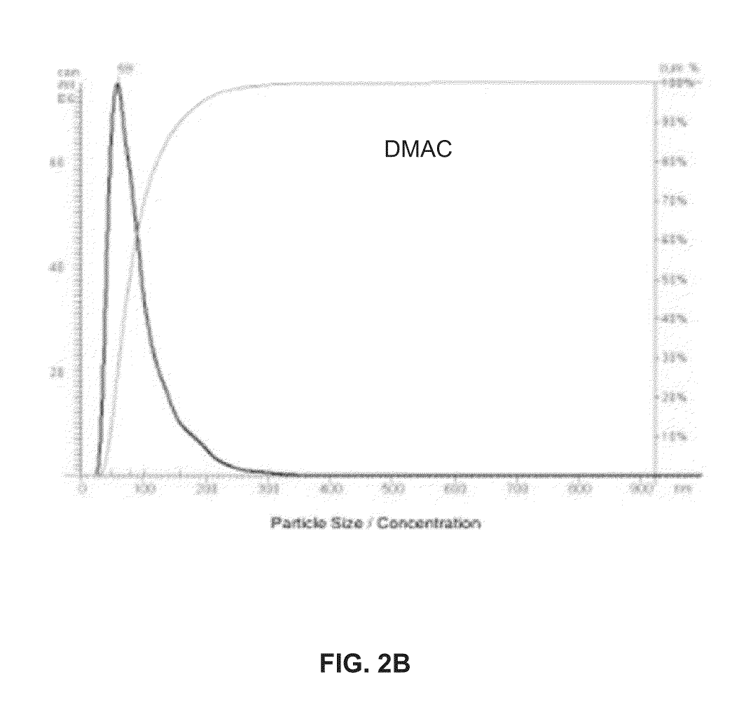

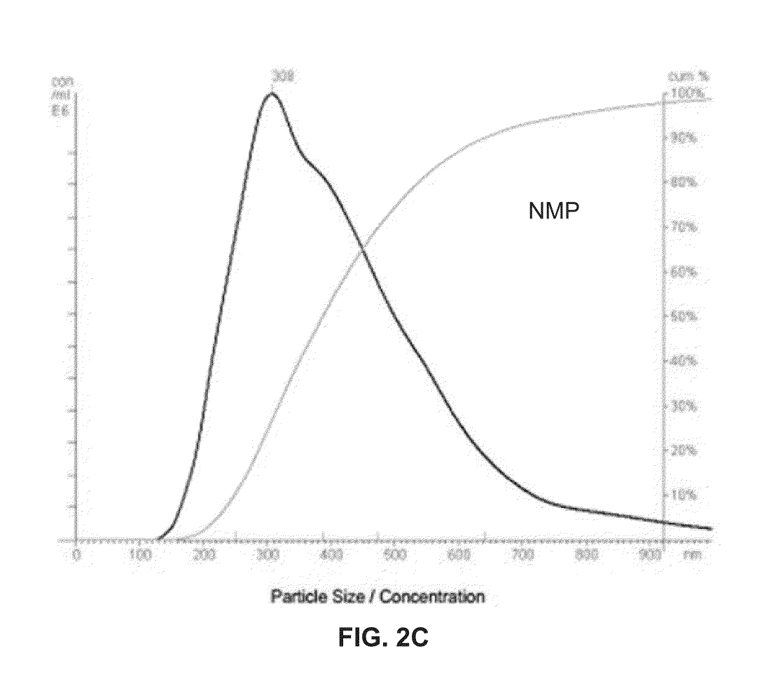

For nSi produced using the solvent-based process, Applicants have discovered that the particle size and homogeneity of the nSi powder surprisingly can be varied and controlled, at least partially, by changing the order or rate of addition of the silicon source, reducing agent, solvent, and/or chemical activator. This is illustrated in FIGS. 1A to 1C, which show Brownian Motion Microscope data for solvent-based reactions according to embodiments of the present invention. In FIG. 2A, SiCl₄ was slowly added over 4 hours to a suspension of Mg in THF. This resulted in >90% of analyzed particles being less than 100 nm in size with a mean size of 77 nm and surface area of 45 m²/g. In FIG. 2B, SiCl₄ was slowly added over 4 hours to a suspension of Mg in DMAC, the average particle size is much smaller (a mean of 53 nm) with >99% of particles below 100 nm and a surface area of 72 m²/g. However, as shown in FIG. 2C, when SiCl₄ was slowly added over 4 hours to a suspension of Mg in NMP, the average particle size is much larger (a mean of 332 nm).

The desired particle size and/or surface area will depend upon the particular application for the nSi, but for energetics applications, a smaller particle size with a maximum surface area will typically result in more rapid and complete combustion process. In particular embodiments, the elemental silicon nanoparticles produced using the methods described herein will have a d₅₀ of about 1 nm to 1000 nm, from about 50 to 100 nm, from about 70 to 90 nm, or about 80 nm. The elemental silicon nanoparticles will have a d₉₀ of about 100 nm and a surface area of about 30-50 m²/g.

The purity of the nSi powder can vary depending upon the exact production method. For example, the ball milling process (without a solvent or activator) will typically result in the presence of unreacted reducing material (such as Mg). Preferably, elemental silicon nanoparticles produced using the methods described herein will be at least about 90% silicon, at least about 95% silicon, at least about 98% silicon, at least about 99% silicon, or at least about 99.9% silicon. In particular embodiments, the elemental silicon nanoparticles will be “high purity” samples, which as used herein means that the sample will have a purity (percentage of silicon) of at least about 98.0%.

Elemental silicon produced according to embodiments of the present invention can be in the form of a dry powder, a suspension, a slurry, a paste, or formed into solid pellets, ingots, boules, or wafers. Uses of these forms of elemental silicon include, but are not limited to nSi suspensions used for antistatic coatings, antireflective coatings, active or inactive layers in photovoltaic devices, anodes or cathodes in batteries, fuel additives, quantum dots, medical diagnostics, and catalysts based on size, size range, purity, functionalization, surface chemistry, additives, and surface area; nSi slurries used for antistatic coatings, antireflective coatings, active or inactive layers in photovoltaic devices, semiconductive paints, silkscreened circuits, disposable circuits, printed circuits, fuel additives, quantum dots, medical diagnostics, flares, pyrotechnics, propulsion, rocket motors, fuses, fuel, and catalysts based on size, size range, purity, functionalization, surface chemistry, additives, and surface area; and nSi paste used for antistatic coatings, antireflective coatings, active or inactive layers in photovoltaic devices, semiconductive paints, silkscreened circuits, disposable circuits, printed circuits, quantum dots, medical diagnostics, fuel, fuel additives flares, pyrotechnics, propulsion, rocket motors, fuses, fuel air weapons, and catalysts based on size, size range, purity, functionalization, surface chemistry, additives, and surface area.

Uses for dry and/or solid forms of the elemental silicon include, but are not limited to nSi powder used for antistatic coatings, antireflective coatings, active or inactive layers in photovoltaic devices, semiconductive paints, silkscreened circuits, disposable circuits, printed circuits, quantum dots, medical diagnostics, fuel, fuel additives flares, pyrotechnics, propulsion, rocket motors, fuses, fuel air weapons, and catalysts based on size, size range, purity, functionalization, surface chemistry, additives, and surface area; nSi pellets used for fuel, fuel additives flares, pyrotechnics, propulsion, rocket motors, fuses, fuel air weapons, and catalysts based on size, size range, purity, functionalization, surface chemistry, additives, and surface area; and pressed solid silicon ingots, boules, or wafers; and pressed solid nSi used to produce monocrystalline or polycrystalline silicon ingots, boules, or wafers by normal or inductive furnaces, isostatic pressing, nanoforging, or laser sintering.

Embodiments described herein, particularly the solution-phase process, are particularly suitable for large scale commercial production of nSi particles. The combination of THF and toluene as a chemical activator and solvent, respectively, can be scaled into a continuous process with higher yields and lower costs than the batch processes typical of prior art production methods.

Embodiments of the invention include batch production processes (for preparing one or more batches of product in sequence) or in a continuous production process. Continuous production processes, while often more complex in terms of equipment and operation, offer greater throughput rates with less product variation than can typically be achieved in batch-to-batch reactions. Moreover, the order and rate of reagent addition can easily be varied in continuous processes, which will allow for greater control of the nSi purity and particle size as discussed above. Lastly, it is easier to minimize temperature variations in continuous processes, which could be critical due to the exothermic nature of the proposed process.

A continuous flow solution-phase reaction system suitable for producing elemental silicon using the methods described herein could make use of industrial flow-through reactors manufactured from pipes containing static mixing elements. As the reaction fluid is pumped through the pipes the elements cause turbulent flow, mixing the reagents and producing a homogeneous reaction medium. In particular embodiments, a flow-through reactor comprises a series of stainless steel pipes containing static mixing elements in an up-down serpentine configuration. Due to the large surface area, excess heat from the exothermic reaction will readily dissipate from exterior pipe walls.

Injection ports, located between pipes throughout the length of the reactor, are used to add reagents and remove sample product for analysis. The location of injection ports will be determined by the order and rate of reagent addition, as these factors play a major role in controlling particle size. Variables for the continuous flow process include flow rate, reactor volume (total length), rate and location of silicon source (SiCl₄) addition, temperature, pressure, and solvent system. By sampling the reaction liquid at various points along the system, a person of skill will be able to determine the optimum conditions to achieve maximum yield and ideal particle size and homogeneity.

Components to be mixed are pushed through the system at the desired volumetric flow rates by a suitable pump, such as a positive displacement pump. The residence time in the system is a function of the reactor volume and the flow rate. Flow rate will be determined primarily by the particle size of the reducing agent powder. In order to ensure complete conversion, the reducing agent powder must stay suspended in the solvent without settling on the mixing elements. Preferably at least about 99% of the magnesium (or other reducing agent) will be consumed prior to reaching the end of the reactor. In some embodiments, the system comprises modular mixing units so that additional lengths of piping can be added to the reactor to ensure complete conversion.

In operation, the silicon source, reducing agent, and chemical activator will be added to a solvent such as toluene circulating within the flow-through reactor. A tangential flow filtration (TFF) process can be used to remove impurities from the fluid flow. In TFF, the feed is passed across the filter membrane tangentially at positive pressure relative to the permeate side. A portion of the material which is smaller than the membrane pore size passes through the membrane as permeate; everything else is retained on the feed side of the membrane as retentate. The tangential motion of the fluid across the membrane causes trapped particles on the filter surface to be rubbed off, which allows the process to operate continuously at relatively high solids loads with minimal clogging.

The primary byproduct of the nSi production process described herein will be a salt, such as MgCl₂, which is soluble in the proposed reaction solvent. Other impurities include excess SiCl₄ and a very small amount of nSi below the membrane pore size. As the reactor product stream enters the TFF unit, these impurities will be forced through the membrane. Approximately half of the volume will cross the membrane thus concentrating the desired nSi product.

After the as-produced nSi has been purified using TFF, it can be sent back into a portion of the flow-through reactor for passivation, as discussed above. Once passivation is complete, the solution or suspension of nSi particles can be dried to a sold powder using a spray-drying system. Collection efficiency will be calculated by comparing the mass of nSi in the incoming slurry to the mass of dry powder isolated after each run. If the efficiency is less than 95%, the system can be tuned by adding a filtration unit or decreasing the gas flow rate. QC testing can be conducted at every subcomponent processing step to ensure quality product. In some embodiments, the solution or suspension of nSi particles can remain in slurry form instead of being dried.

The invention described herein has broad applicability and can provide many benefits as discussed and shown in the examples above. The embodiments will vary greatly depending upon the specific application, and not every embodiment will provide all of the benefits and meet all of the objectives that are achievable by the invention. Note that not all of the activities described above in the general description or the examples are required, that a portion of a specific activity may not be required, and that one or more further activities may be performed in addition to those described. Still further, the order in which activities are listed are not necessarily the order in which they are performed.

Although the description of the present invention above is mainly directed at the production of nSi for applications such as propellants, explosives, or thermites, it should be recognized that the invention could be applicable to any application where elemental silicon can be employed, including without limitation photovoltaic devices, printed circuit devices, quantum dots, medical diagnostics, fuel, fuel additives, and/or catalysts. Whenever the terms “automatic,” “automated,” or similar terms are used herein, those terms will be understood to include manual initiation of the automatic or automated process or step.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention. After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present). Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Although the present invention and its advantages have been described in detail, it should be understood that various changes, substitutions and alterations can be made to the embodiments described herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1-46. (canceled)

47. A process for producing high purity elemental silicon comprising the steps of:
combining a silicon source and a reducing agent into a reactor, the reducing agent reacting with the silicon source to produce elemental silicon nanoparticles; and
introducing a chemical activator into the reactor, the chemical activator serving to enhance the rate of reaction of the silicon source and the reducing agent and/or serving to decrease the initiation temperature of the reaction;
wherein the reaction of the silicon source and the reducing agent in the presence of the chemical activator is conducted at a temperature of less than about 500° C.

48. The process of claim 47 in which the silicon source comprises a silicon-containing compound in which silicon is present in a plus 4 oxidation state.

49. The process of claim 47 in which the silicon source comprises silicon tetrachloride.

50. The process of claim 47 in which the silicon source comprises a silicon halide, a silicon alkoxide, a silicon ester, a silane, a silicon hydrocarbon halide, a mixed hydrocarbon halide, or any combination thereof.

51. The process of claim 47 in which the reducing agent comprises magnesium powder.

52. The process of claim 47, in which the reducing agent comprises Mg, Al, Li, Na, K, Ca, Cu, Cs, Sr, Be, Zn, Zr, Ba, Mn, Cr, P, B, or any combination thereof.

53. The process of claim 47 in which the chemical activator comprises tetrahydrofuran (THF).

54. The process of claim 47 in which the chemical activator comprises diethyl ether, acetone, acetonitrile, benzene, benzonitrile, N,N-dimethylacetimide (DMAC), N,N-dimethylformamide (DMF), dimethylsulfoxide, ethylacetate, formamide, hexamethylphosphoramide, 1-methyl-2-pyrrolidone (NMP), nitrobenzene, nitromethane, propylene carbonate, pyridine, THF, propylene carbonate (PC), linear, cyclic, and/or polymeric esters, dry alcohols, diether ether (ether), linear, cyclic, and/or polymeric ethers, or any combination thereof.

55. The process of claim 47 further comprising introducing a solvent into the reactor, the solvent capable of dissolving a non-silicon containing salt or byproduct of the reaction.

56. The process of claim 55 in which the solvent comprises toluene, methylene chloride, THF, diethyl ether, acetone, acetonitrile, benzene, benzonitrile, N,N-dimethylacetimide (DMAC), N,N-dimethylformamide (DMF), dimethylsulfoxide, ethylacetate, formamide, hexamethylphosphoramide, 1-methyl-2-pyrrolidone (NMP), nitrobenzene, nitromethane, propylene carbonate, and pyridine, dry alcohols, cyclic and linear ethers, or any combination thereof.

57. The process of claim 47 further comprising reacting the reducing agent with the silicon source in the presence of a mechanical activator.

58. The process of claim 57 in which the mechanical activator comprises ball milling, high speed ball milling, jet grinding, static mixing elements, sonication, high shear mixing, high or low pressure homogenization, or wet grinding.

59. The process of claim 47 further comprising, after reacting the reducing agent with the silicon source in the presence of the chemical activator to produce elemental silicon nanoparticles, isolating the silicon nanoparticles from the mixture.

60. The process of claim 59 further comprising, after isolating the silicon nanoparticles from the mixture, stabilizing the silicon nanoparticles by forming an organic passivation layer on the surfaces of the silicon nanoparticles.

61. The process of claim 47 in which the elemental silicon nanoparticles comprise at least about 90% silicon.

62. The process of claim 47 in which the elemental silicon nanoparticles have a d₅₀ of about 1 nm to 1000 nm.

63. The process of claim 47 in which the size of the elemental silicon nanoparticles can be varied by changing the order or rate of addition of the silicon source, solvent, reducing agent, and/or chemical activator.

64. The process of claim 47 in which the reaction producing the elemental silicon nanoparticles is substantially completed within about 24 hours from the time the silicon source, reducing agent, and chemical activator are combined.

65. The process of claim 47 in which the reaction producing the elemental silicon nanoparticles is spontaneous once the silicon source, reducing agent, and chemical activator are combined.

66. Elemental silicon produced by the process described in claim 47, having a purity of at least about 98%.

67. A process for producing high purity elemental silicon comprising reacting a reducing agent with a silicon source, isolating silicon nanoparticles produced in the reaction, and stabilizing the silicon nanoparticles by forming an organic passivation layer on the surfaces of the silicon nanoparticles.

68. A process for producing high purity elemental silicon comprising reacting a reducing agent with a silicon source at low temperatures or room temperatures.

69. The process of claim 68 in which the reaction of the reducing agent and the silicon source proceeds as a purely solvent-based reaction without mechanical agitation.

70. The process of claim 68 in which the reaction of the reducing agent and the silicon source takes place in the presence of a chemical activator.

71. The process of claim 70 in which the chemical activator serves to enhance the rate of reaction of the silicon source and the reducing agent and/or serving to decrease the initiation temperature of the reaction.
